(19) United States
(12) Patent Application Publication
(10) Pub. No.: US 2025/0225383 A1
(43) Pub. Date: Jul. 10, 2025

(54) FIBER-BASED ARTIFICIAL NEURON UNIT

(71) Applicant: COGNIFIBER LTD., Rosh Ha’Ayin (IL)

(72) Inventors: Eyal COHEN, Gedera (IL); Zeev ZALEVSKY, Rosh Ha'Ayin (IL); Maya YEVNIN, Tel Aviv (IL); Alon HAREL, Rosh Ha'Ayin (IL); Or Arbel ARENFRID, Rosh Ha'Ayin (IL)

(21) Appl. No.: 18/939,788

(22) PCT Filed: May 3, 2023
(86) PCT No.: PCT/IL2023/050455

§ 371 Date: Nov. 7, 2024

Related U.S. Application Data
(60) Provisional application No. 63/340,575, filed on May 11, 2022.

(51) Int. Cl. G06N 3/067

(52) U.S. Cl. CPC G06N 3/0675

(57) ABSTRACT

An artificial neural unit for signal processing is presented. The artificial neuron unit comprises: a fiber-based optical processing unit having first and second light input ports and first and second light output ports, and being configured and operable to controllably apply optical processing to incoherent input light signals and produce weighted first and second combined light signals; and an electro-optical processing unit configured and operable to process said weighted first and second combined light signals and produce a total weighted output of the artificial neuron unit, by successively performing the following: applying a predetermined mathematical function to said weighted first and second combined light signals corresponding to positive and negative weighting and producing a resulting signal; and applying a non-linear processing to the resulting signal to translate said resulting signal into an optical output signal representing said total weighted output of the artificial neuron unit.

### TECHNOLOGICAL FIELD

The present disclosure is in the field of artificial neural networks, and relates to a fiber-based neuron unit and neural network utilizing the same.

### BACKGROUND ART

References considered to be relevant as background to the presently disclosed subject matter are listed below:
1. R. Xu, P. Lv, F. Xu, and Y. Shi, “A survey of approaches for implementing optical neural networks,” Optics & Laser Technology, vol. 136, pp. 106787, 2021, DOI: 10.1016/j.optlastec.2020.106787.
2. X. Sui, Q. Wu, J. Liu, Q. Chen, and G. Gu, “A review of optical neural networks,” IEEE Access, vol. 8, pp. 70773-70783, 2020, DOI: 10.1109/ACCESS.2020.2987333.
3. B. Shi, N. Calabretta, and R. Stabile, “Deep Neural Network Through an InP SOA-Based Photonic Integrated Cross-Connect,” IEEE Journal of Selected Topics in Quantum Electronics, vol. 26, pp. 1-11, 2020, DOI: 10.1109/JSTQE.2019.2945548.
4. A. Totovic, G. Giamougiannis, A. Tsakyridis, D. Lazovsky, and N. Pleros, “Programmable photonic neural networks combining WDM with coherent linear optics,” Scientific reports, vol. 12, pp. 5605, 2022, DOI: 10.1038/s41598-022-09370-y.
5. H. Zhang, M. Gu, X. D. Jiang, J. Thompson, H. Cai, S. Paesani, R. Santagati, A. Laing, Y. Zhang, M. H. Yung, Y. Z. Shi, F. K. Muhammad, G. Q. Lo, X. S. Luo, B. Dong, D. L. Kwong, L. C. Kwek, and A. Q. Liu, “An optical neural chip for implementing complex-valued neural network,” Nature Communications, vol. 12, pp. 1-11, 2021, DOI: 10.1038/s41467-020-20719-7.
6. J. Liu, Q. Wu, X. Sui, Q. Chen, G. Gu, L. Wang, and S. Li, “Research progress in optical neural networks: theory, applications and developments,” PhotoniX, vol. 2, pp. 1-39, 2021, DOI: 10.1186/s43074-021-00026-0.
7. E. Cohen, D. Malka, A. Shemer, A. Shahmoon, Z. Zalevsky, and M. London, “Neural networks within multi-core optic fibers,” Scientific Reports, vol. 6, pp. 29080, 2016, DOI: 10.1038/srep29080.
8. A. N. Tait, T. Ferreira De Lima, M. A. Nahmias, H. B. Miller, H. T. Peng, B. J. Shastri, and P. R. Prucnal, “Silicon Photonic Modulator Neuron,” Physical Review Applied, vol. 11, pp. 064043, 2019, DOI: 10.1103/PhysRevApplied.11.064043.
9. X. Xu, M. Tan, B. Corcoran, J. Wu, A. Boes, T. G. Nguyen, S. T. Chu, B. E. Little, D. G. Hicks, R. Morandotti, A. Mitchell, and D. J. Moss, “11 TOPS photonic convolutional accelerator for optical neural networks,” Nature, vol. 589, pp. 44-51, 2021, DOI:10.1038/s41586-020-03063-0.

Acknowledgement of the above references herein is not to be inferred as meaning that these are in any way relevant to the patentability of the presently disclosed subject matter.

### BACKGROUND

Photonic computing holds the promise of achieving low-power and high-speed solutions to real-time machine learning and artificial intelligence applications, supporting future scalable and sustainable computing ecosystems which are expected to grow exponentially over the next decade. Most of the photonic computing solutions proposed to date rely on photonic integrated circuit (PIC) technology, silicon photonics chips (SIPH), or free-space optics [1-3] and use coherent interactions for the multiply-accumulate (MAC) operations [4-6]. These technologies encompass several issues including yield and scaling limitations due to large chip size, large accumulated loss over the numerous Mach-Zender Interferometers (MZI) included in most designs, the required tight phase control, and high sensitivity to local temperature or vibrations.

Also, in neural networks utilizing multiple cascaded MZIs, the linear algebraic summations over a set of neuron inputs are realized by coherent electric field addition exploiting the phase of the optical carrier electric field for sign-encoding purposes. This coherent approach causes accumulation of signal errors along the cascade of MZIs and precludes obtaining high enough precision and low enough bit error rates for large scale practical applications.

Fiber-based neural networks have been developed. These technique offers a platitude of devices, which are larger in volume, but are based on mature technologies with high bandwidth and low power specifications alongside off-the-shelf availability and proven reliability.

The inventors have previously demonstrated an in-fiber-based optical computing unit, that combined with standard devices such as transceivers and Erbium-doped fiber amplifiers delivered both linear and non-linear functions required for neural network. While single unit results were impacted by coherence-induced phase-noise, a redundancy-assisted full network emulation (ResNet-18) demonstrated far-superior performance and accuracy over existing technologies [7,8]. Also, various configurations of optical neural network units are described for example in WO19186548 and WO21064727 assigned to the assignee of the present application.

### GENERAL DESCRIPTION

There is a need in the art for a novel approach for the configuration and operation of an artificial neuron unit, being a basic block in an artificial neural network, performing various signal processing tasks.

Generally, an Artificial Neural Network (ANN) is a computational model inspired by the way the biological nervous system, such as brain, processes information. It is composed of a large number of highly interconnected systems, consisting of basic computational units or neurons. The artificial neuron is configured to process an input signal being received and then transmit a corresponding signal to artificial neuron/s connected thereto. Typically, artificial neurons are arranged in layers. Different layers may perform different kinds of transformations on their inputs and transmit a corresponding output signal. Signals travel from the first (input), to the last (output) layer, possibly after traversing the different layers several times.

As described above, most of the known photonic computing solutions rely on PIC technology, SIPH, or free-space optics and use coherent interactions for the multiply-accumulate (MAC) operations. The present disclosure provides a novel approach for a photonic computing system which utilizes hybrid fiber technology and electro-optical communication devices, featuring negative and positive weighting schemes under incoherent data transmission conditions. The inventors have shown that such configuration provides for achieving 5-20 factor acceleration while increasing power efficiency by two or more orders of magnitude.

Specifically, an artificial neuron of the present disclosure is implemented as a hybrid optical-electrical-optical (OEO) unit, where neural network computations are performed on incoherent light propagating in fibers. The inputs {x} and the output yⱼ of each neuron unit are optical, whereas the optical signals, after proper weighing during propagation in the fiber-based optical portion of the neuron unit, undergo linear mathematical operation while interacting with an electro-optical portion of the neuron unit which transforms the optical signals to electronic signals and then into an optical output. It should be noted that operating with incoherent light signals, rather than coherent light, produces less “coherence noise” associated with interference effects, and also provides more stable (versus environmental conditions) processing performance.

Thus, according to one broad aspect of the present disclosure, it provides an artificial neural unit for signal processing, the artificial neuron unit comprising:
a fiber-based optical processing unit having first and second light input ports and first and second light output ports, and being configured and operable to controllably apply optical processing to incoherent input light signals, and produce weighted first and second combined light signals; and
an electro-optical processing unit configured and operable to process said weighted first and second combined light signals and produce a total weighted output of the artificial neuron unit, by successively performing the following: applying a predetermined mathematical function to said weighted first and second combined light signals corresponding to positive and negative weighting and producing a resulting signal; and applying a non-linear processing to the resulting signal to translate said resulting signal into an optical output signal representing said total weighted output of the artificial neuron unit.

In some embodiments, the electro-optical processing unit comprises: a linear processor having an optical input coupled to said first and second light output ports and being configured and operable to process said weighted first and second combined light signals by applying the predetermined mathematical function thereto corresponding to positive and negative weighting, and output a resulting electronic signal; and a non-linear processor adapted to receive an input signal indicative of the resulting electronic signal and configured and operable to translate said input signal into an optical output signal representing a total weighted output of said artificial neuron unit.

In some embodiments, the fiber-based optical processing unit has the following configuration: The fiber-based optical processing unit comprises first and second splitters at the first and second light input ports, respectively, and first and second combiners at the first and second light output ports, respectively. The first splitter is configured to split the first light input port, by a predetermined ratio, into a first pair of separate first and second light propagation paths, and the second splitter is configured to split the second light input port, by said predetermined ratio, into a second pair of separate first and second light propagation paths, thereby producing first and second pairs of light propagation paths. The first combiner combines the first light propagation paths of the first and second pairs at the first light output port producing a first combined light signal, and the second combiner combines the second light propagation paths of the first and second pairs combined at the second light output port producing a second combined light signal. At least one of the first and second light propagation paths of each of the first and second pairs is configured to apply variable optical attenuation (VOA) to light propagating therethrough. By this, weighing is applied to the incoherent input light signals propagating through the respective at least one of the first and second light propagation paths of each of the first and second pairs, such that the first combined light signal and the second combined light signal are thereby, respectively, said weighted first and second combined light signals.

In some embodiments, the linear processor comprises a dual balanced photodiode configured and operable to process the weighted first and second combined light signals and produce the electronic signal proportional to a difference between the weighted first and second combined light signals, thereby realizing, respectively, positive and negative weighting with the first and the second combined light signals.

In some embodiments, the non-linear processor is configured as an electro-optical device, the input signal being received by the non-linear processor being the resulting electronic signal output of the linear processor. For example, as described above, the linear processor comprises the dual balanced photodiode. In this case the non-linear processor may be implemented based on the electronic non-linearity of the photodiode, which can be adjusted in accordance with the desired non-linear translation to be performed. The non-linearity response of the circuit can be modulated/adjusted either by changing the photodiodes, changing the operating point of the photodiodes, or any of the other circuit elements following it (i.e. amplifier).

In some other embodiments, the non-linear processor is configured as an optical active device, the input signal being received by the non-linear processor being an optical signal corresponding to the resulting electronic signal output of the linear processor.

The artificial neural unit may further include a control board configured and operable to control operation of the fiber-based optical processing unit and the electro-optical processing unit.

In some embodiments, the control board comprises: a weighting controller configured and operable to generate a control signal to the fiber-based optical processing unit to apply variable optical attenuation to light propagating through the optical processing unit; a linear controller configured and operable to define coefficients of said mathematical function corresponding to weighted summation of said weighted first and second combined light signals; and a non-linear controller configured and operable to define a shape of a non-linear function that translates the weighted summation to the optical output signal representing the total weighted output of the artificial neuron unit.

According to another broad aspect of the present disclosure, it provides an artificial neural network comprising two or more neuron layers arranged such that optical input of a successive layer of said two or more layers is coupled to optical output of a preceding layer of said two or more neuron layers. Each of said two or more neuron layers is formed by a number of independently operable artificial neuron units having the above-described configuration.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows schematically a functional scheme of an artificial neuron unit configured according to the present disclosure as a hybrid optical-electrical-optical processing unit;

FIG. 2A shows schematically a general scheme of an artificial neuron unit of the present disclosure;

FIG. 2B shows schematically the configuration of an artificial neuron unit of the present disclosure, specifically the configuration of the fiber-based optical processing unit;

FIG. 2C exemplifies schematically a non-limiting embodiment of the artificial neuron unit of the present disclosure;

FIG. 3A shows schematically the system architecture of an artificial neural network according to the present disclosure;

FIG. 3B shows a photo of the assembled system;

FIGS. 4A to 4C show results of characterization of timing of positive and negative outputs, wherein FIG. 4A shows a 20 ns pulse at 1550 nm injected into a single neuron input; FIG. 4B shows the same pulse, with 40 cm delay line (equivalent to 2 ns) added to the positive optical path; and FIG. 4C shows results when a 4-level step input signal is injected into 2 input ports: input1 with step period of 10ns and input 2 with step period of 40 ns. The plot depicts the output when both VOAs are fully closed, fully open, and with one VOA closed and the other open; and

FIG. 4D shows measured output values vs. the expected values.

### DETAILED DESCRIPTION OF EMBODIMENTS

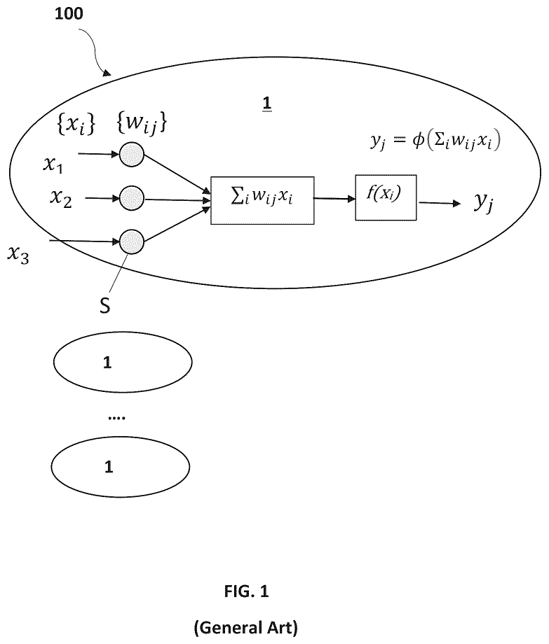

Reference is made to FIG. 1 describing a general scheme of an exemplary artificial neuron unit (neuron) 1. Such neuron 1 can be used as an individual node of an artificial neural network 100.

The neural network 100 typically includes two or more layers operable in cascaded fashion, where each layer includes a plurality of individually operable neurons 1. In the figure, a single layer is illustrated. As shown, the neuron 1 is configured and operable as follows: neuron 1 includes two or more inputs-three such inputs being shown in the figure, for receiving corresponding input signals (x₁, x₂, . . . xᵢ), e.g. from neurons of the preceding layer (not shown). The input signals received by the neuron 1 are linearly weighted by synapses S (by weights (w₁ⱼ, W₂ⱼ, . . . . Wᵢⱼ)), and then summed producing linear neuron signal which is nonlinearly transformed (by a nonlinear transfer (activation) function) generating a single neuron output (yⱼ). The weight applied by the synapse S may have either a positive or a negative value, where a positive weight activates the neuron while a negative weight inhibits it. The nonlinear function applied to the linear neuron signal may include logistic function (sigmoid), rectified linear units (ReLU), inverse square root linear units (ISRU) etc., depending on the neural model used.

It should be noted that interaction between incoherent optical signals being input to the neuron would not by itself allow negative weighting because such interaction does not affect the phase. Hence, it is challenging to implement negative weighting by the neuron operating with the incoherent signals, while use of incoherent signals is important and preferred for various applications. In particular, as indicated above, operation with incoherent light signals produces less “coherence noise” and provides more stable processing performance.

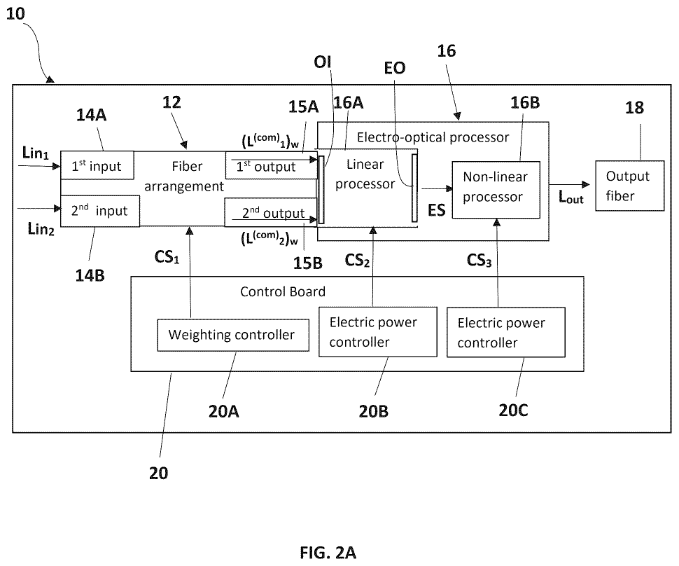

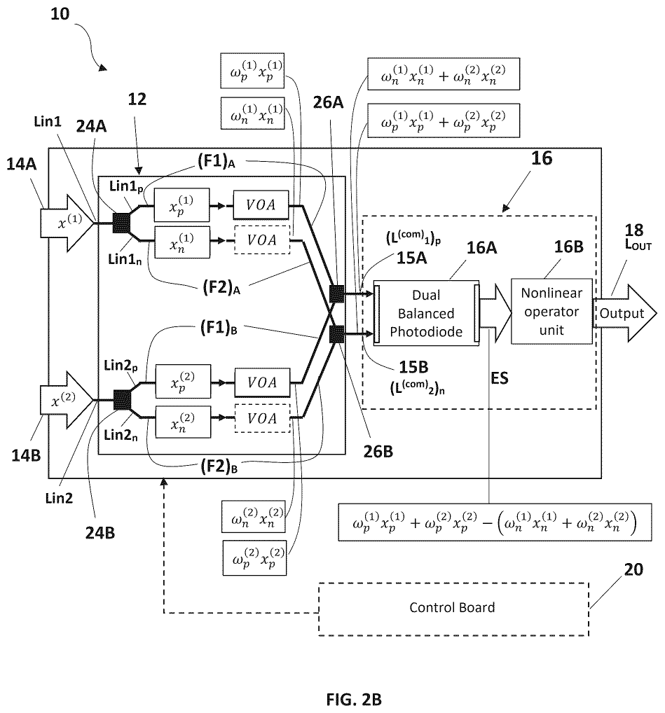

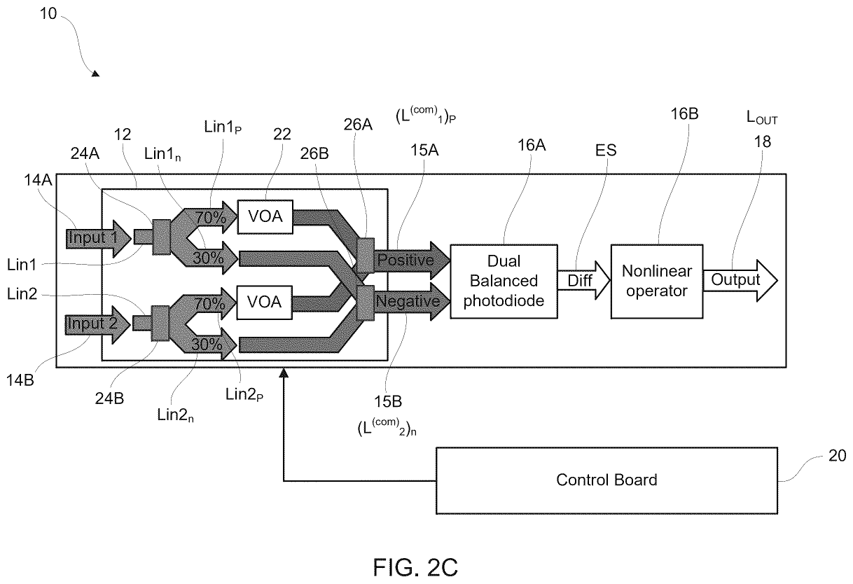

Reference is made to FIG. 2A illustrating schematically the configuration and operation of an artificial neuron unit 10 according to the present disclosure which is configured for operation with incoherent input signals and is capable of properly providing positive and negative weights.

The inventors were inspired by the push-pull mechanism describing interaction between excitation and inhibition during neural processing throughout the central nervous system. In short, when inhibition is coupled to excitation in a push-pull fashion, where inhibition decreases as excitation increases, neuron excitability can be increased. The inventors used the principles of such push-pull mechanism in order to realize positive and negative weighting.

The artificial neuron unit 10 of the present disclosure is configured as a hybrid system of a fiber-based optical processing unit 12 and an electro-optical processing unit 16. The fiber-based optical processing unit 12 (fiber arrangement) has first and second light input ports 14A and 14B for inputting respective first and second incoherent input signals Lin₁ and Lin₂, and has first and second light output ports 15A and 15B. The fiber-based optical processing unit 12 is configured and operable to controllably apply optical processing to the incoherent input light signals and produce first and second weighted combined light signals (L^{(com)}₁)_{w} and (L^{(com)}₂)_{w}. Each of these weighted combined light signals is formed by a combination of respective weighted portions of the first and second incoherent input signals Lin₁ and Lin₂.

The electro-optical processing unit 16 includes a linear processor 16A and a non-linear processor 16B. The linear processor 16A has an optical input OI coupled to the first and second light output ports 15A and 15B of the optical unit 12 and is configured and operable to process the first and second weighted combined light signals (L^{(com)}₁)_{w} and (L^{(com)}₂)_{w} by applying a predetermined mathematical function thereto corresponding to positive and negative weighting, producing a resulting electronic signal ES being output via an electric output port EO of the linear processor 16A.

The non-linear processor 16B may be configured as an electro-optical device, e.g., the non-linearity can be implemented based on electronic non-linearity of the photodiode of the linear processor (i.e., the response of the photodiode has linear range and then a saturation when the electrical capacitor is full). Adjustment of photodiode non-linearity can be achieved by replacing the type of photodiodes or changing the operating point by changing one or few of the circuit voltages.

Alternatively, the non-linear processor 16B may be configured as an optical active device, such as an Erbium-Doped Fiber Amplifier (EDFA) or Semiconductor Optical Amplifier (SOA) where input signal(s) compete for gain resources (cross-gain modulation) or through nonlinear processes such as Kerr effect (cross-phase modulation), etc. Such optical non-linear processors/operators are known and are described for example in WO2021064727 and US2022327372 (assigned to the assignee of the present application) which are incorporated herein by reference.

Thus, generally, the non-linear processor 16B is adapted to receive an input signal indicative of an electronic signal being output by the linear processor 16A and is configured and operable to translate this input signal into an optical signal Lₒᵤₜ which represents the total weighted output of the artificial neuron unit 10. This optical signal Lₒᵤₜ is allowed to propagate in an output optical fiber 18, e.g., being an input fiber of a neuron unit of the successive layer.

Considering the electro-optical configuration of the non-linear processor 16B, it may be directly coupled to electric output EO of the linear processor 16A and operate to convert the electronic signal ES being output from the processor 16A into the optical output signal Lₒᵤₜ to propagate in the output optical fiber 18. It should be noted, although not specifically shown in the figure, that in case of the optical configuration of the non-linear processor 16B, the neuron unit 10 also includes an electro-optical converter of any known suitable configuration, e.g., laser diode with low coherence length, arranged upstream of the non-linear processor 16B.

The neuron unit 10 is associated with (e.g., includes) a control board 20. The control board 20 includes a weighting controller 20A, and two electric power controllers 20B and 20C. The weighting controller 20A is configured and operable to apply a control signal CS₁ to the optical processing unit to induce e.g. variable optical attenuation of light propagating through the optical processing unit 12, as will be described further below. The electrical power controllers 20B and 20C are configured and operable to control the linear processor 16A and the non-linear processor 16B, respectively. More specifically, the controller 20B is configured and operable to define coefficients of the weighted summation and generate a corresponding operational data/signal CS₂ to the linear processor 16A; and the controller 20C is configured and operable to define a shape of the non-linear function that translates the weighted sum of inputs embedded in the electronic signal ES being output from the linear processor 16B into the optical output signal Lₒᵤₜ, and generates a corresponding control data/signal CS₃ to operate the non-liner processor 16B.

Reference is made to FIG. 2B illustrating schematically the neuron unit 10 of the present disclosure and describing in detail the operation of the fiber-based optical processing unit 12. The same reference numbers are used to identify functionally common components of all the examples.

Thus, neuron unit 10 of FIG. 2B is configured generally similar to that of FIG. 2A, namely is configured as a hybrid system of a fiber-based optical processing unit 12 and an electro-optical processing unit 16, and may be associated with a control board 20. The fiber-based optical processing unit 12 has first and second light input ports 14A and 14B for receiving incoherent input signals, and has first and second light output ports 15A and 15B, optically coupled to the optical input of the linear processor 16A which receives the first and second weighted combined light signals (L^{(com)}₁)_{w} and (L^{(com)}₂)_{w} and applies thereto a predetermined mathematical function corresponding to positive and negative weighting. The so-produced electronic signal ES is received and processed by non-linear processor 16B which converts the electronic signal into an optical output signal Lₒᵤₜ representing the total weighted output of the artificial neuron unit 10.

As shown in FIG. 2B, the light input signals at the light input ports 14A and 14B of the optical processing unit 12 are x⁽¹⁾ and x⁽²⁾. The fiber-based optical processing unit 12 includes splitters 24A and 24B at the input ports 14A and 14B, respectively. The splitter 24A is configured to split, in a predetermined ratio, the input light field Lin1 into two light portions Lin1ₚ and Lin1ₙ propagating along two respective fibers F1_{A} and F2_{A}. Similarly, the splitter 24A is configured to split, in a predetermined ratio, the input light field Lin2 into two light portions Lin2ₚ and Lin2ₙ propagating along two respective fibers F1_{B} and F2_{B}. Thus, each of the first and second light input signals entering the processor 12 via the input ports 14A and 14B is split, by a predetermined ratio, into a pair of separate first and second light propagation paths.

Thus, the two arms of the fiber-based processor, associated with the two inputs 14A and 14B, provide the first pair of light propagation paths F1_{A} and F2_{A} propagating light portions Lin1ₚ and Lin1ₙ of the input light Lin1 having respective light signals xₚ⁽¹⁾ and xₙ⁽¹⁾, and the second pair of light propagation paths F1_{B} and F2_{B} propagating light portions Lin2ₚ and Lin2ₙ of the input light Lin2 having respective light signals xₚ⁽²⁾ and xₙ⁽²⁾.

At least one of the first and second light propagation paths of each of the first and second pairs F1_{A}-F2_{A} and F1_{B}-F2_{B} carries a controlled optical attenuator (VOA) 22 which is configured to apply variable optical attenuation (VOA) to light propagating therethrough. By this, weighting (e.g., wₚ⁽¹⁾, wₙ⁽¹⁾, wₚ⁽²⁾, wₙ⁽²⁾) is applied to the incoherent input light portions Lin1ₚ and Lin2ₚ and/or to the input light portions Lin1ₙ and/or Lin2ₙ propagating through, respectively, the first fibers (F1_{A} and F1_{B} and/or the second fibers F2_{A} and F2_{B}.

Further provided in the fiber-based optical processor 12 are optical combiners 26A and 26B configured such that combiner 26A combines the propagation paths F1_{A} and F1_{B}, and thus light portions Lin1ₚ and Lin2ₚ, into the output port 15A, and combiner 26B combines the propagation paths F2_{A} and F2_{B}, and thus light portions Lin1ₙ and Lin2ₙ, into a combined output 15B. As a result, the output light signals propagating through the output ports 15A and 15B are weighted combined signals (L^{(com)}₁)ₚ and (L^{(com)}₂)ₙ. More specifically, the first light propagation paths F1A and F1B of the first and second pairs are coupled to and combined at the first light output port 15A producing the first combined light signal (L^{(com)}₁)ₚ (e.g., ωₚ⁽¹⁾xₚ⁽¹⁾+ωₚ⁽²⁾xₚ⁽²⁾; and the second light propagation paths F2A and F2B of the first and second pairs are coupled to and combined at the second light output port 15B to produce the second combined light signal (L^{(com)}₂)ₙ (e.g., ωₚ⁽¹⁾xₚ⁽¹⁾+ωₚ⁽²⁾xₚ⁽²⁾).

The combined light signals (L^{(com)}₁)ₚ and (L^{(com)}₂)ₙ from the first and second light output ports 15A and 15B of the optical processing unit 12 are fed into the linear processor 16A producing an electric output (electronic signal ES) indicative of a relation between the combined light signals (L^{(com)}₁)ₚ and (L^{(com)}₂)ₙ. In the present not limiting example, the linear processor comprises a dual balanced photodiode, configured and operable to provide the output electronic signal ES proportional to a difference between the weighted first and second combined light signals, e.g., ωₚ⁽¹⁾xₚ⁽¹⁾+ωₚ⁽²⁾xₚ⁽²⁾−ωₙ⁽¹⁾xₙ⁽¹⁾+ωₙ⁽²⁾xₙ⁽²⁾). Thus, respectively, positive and negative weighting with the first and the second combined light signals (L^{(com)}₁)ₚ and (L^{(com)}₂)ₙ is realized.

It should be noted that indexes “p” and “n” used here relate to positive and negative weights, respectively. In the present not limiting example, the positive and negative weightings are assigned to, respectively, the first propagation paths F1A-F1B and the second propagation paths F2A-F2B of the pairs. It should, however, be understood that this may be oppositely defined. It should also be understood that the negative and positive weightings are actually implemented at the combined light signals' interaction with the linear processor 16A, while the magnitude of the weights are defined by the controlled operation(s) of the VOA(s) 22. Thus, these combined light signals being output via output ports 15A and 15B are termed here “weighted” combined light signals.

It is known in the art that having linearity in neural networks is not enough and processing of nonlinear activation functions is required, similar to the function of synapses in the brain nervous system. Non-linear function is needed to accelerate the convergence speed of the network and improve the recognition accuracy, which is an indispensable part of the neural network. The non-linearity can vary from a simple sigmoid to a complex dynamical system, depending on the neural model used.

As described above, the nonlinear function can be realized by a non-linear operator unit 16B electronically or optically. For example, the electrical signal ES from the dual balanced photodiode 16A may drive an electro-optical modulator 16B with an optical pump (from the controller 20C of the control board 20) to generate a nonlinearly transformed optical signal. In another non-limiting example, optical non-linearity can be used being implemented by an optical active device, such as EDFA, in which case a laser diode (a convertor from electrons back to photons) is placed upstream the non-linear module, with respect to the general direction of signal propagation through the neuron unit.

Thus, the resulting analog optical signal Lout represents a total weighted light output propagating to and through an output fiber 18 of the artificial neural unit 10, e.g. to input the successive layer of the network.

As described above and schematically shown in the figure, the artificial neuron unit 10 is associated with the control board 20 configured and operable to control the electro-optical components of the system, e.g., the VOA(s) 22, the dual balanced photodiode 16A and the non-linear operator unit 16B.

In the following, the system architecture, and the neuron performance are more specifically exemplified, as well as the performance of a complete neural network based on the measured results is estimated.

The operation of an exemplary single neuron 10 is schematically shown in FIG. 2C. The neuron unit 10 includes optical processing unit 12 having two inputs 14A and 14B for receiving incoherent input light signals Lin1 and Lin2. As noted above, the neuron 10 employs a push-pull mechanism in order to realize positive and negative weighting. Each of the first and second input light signals, Lin1 and Lin2 is split in a predetermined ration (e.g., 30/70 ratio) by a respective fiber-coupled splitter 24A, 24B to provide a pair of light propagation paths F1A-F1B, F2A-F2B for respective pair of light portions Lin1ₚ-Lin1ₙ, Lin2ₚ-Lin2ₙ. In the present not limiting example, the light portion (Lin1ₚ or Lin2ₚ) passing through the 70% leg of each light propagation path (F1A or F1B), acting as the positive weight, passes through a variable optical attenuator (VOA) 22 controlled individually by the control board 20; and the light portion (Lin1ₙ or Lin2ₙ) passing through the 30% leg of each light propagation path (F2A or F2B) acts as the negative weight and is not attenuated. The positive weights' legs F1A and F1B are combined by fiber-coupled combiner 26A into a positive-weight output port 15A producing a positive-weighted combined light signal (L^{(com)}₁)ₚ; and negative weights' legs F2A and F2B are combined by fiber-coupled combiner 26B into a negative-weight output port 15B producing a negative-weighted combined light signal (L^{(com)}₂)ₙ. These positive weighted and negative-weighted combined light signals (L^{(com)}₁)ₚ and (L^{(com)}₂)ₙ and directed to the optical input of the dual balanced photodiode 16A (linear processor) resulting in an electronic signal ES corresponding to the differential output voltage which is then converted by a nonlinear operator unit 16B into an analog optical signal which represents the total output Lₒᵤₜ of the neuron 10.

As already noted above, in addition to providing a negative weight, the artificial neuron unit 10 is based on a push-pull mechanism of control. If the first input 14A is considered as “excitatory” and the second input 14B is considered as “inhibitory”, then it can be easily shown that by increasing inhibition one may achieve increased total output, i.e., neuron excitability is increased. This illustrates the paradox at the heart of push-pull organization: increased force output can be achieved by increasing background inhibition to provide greater disinhibition. Such organization may be advantageous in designing more robust multi-layer artificial neural networks.

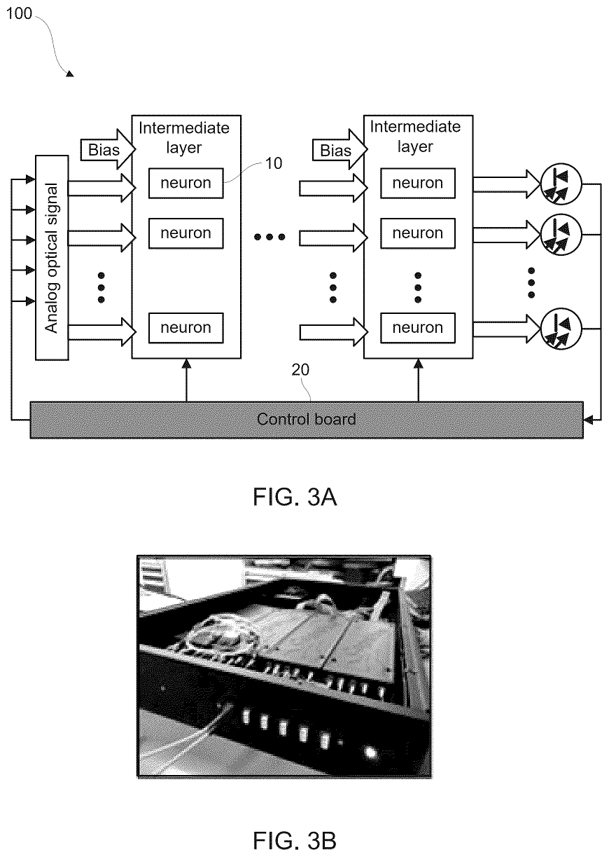

FIG. 3A schematically illustrates a complete photonic/computing system architecture 100, configured as multi-layer neural network, in which each layer is formed by an array of independently operable neuron units 10 configured according to the present disclosure as described above. Analog electronic signals are generated by the control board 20 and are converted into analog optical signals using modulators. These analog optical signals are properly weighed and injected into the first neural layer with addition of bias. Each neuron unit 10 is configured and operable as described above to perform an analog nonlinear function over the sum of weighted inputs and send the resulting amplitude to the next layer. The outputs of the output layer neurons are read by the control board 20 via photodiodes.

The photo of the exemplary assembled system is shown in FIG. 3B.

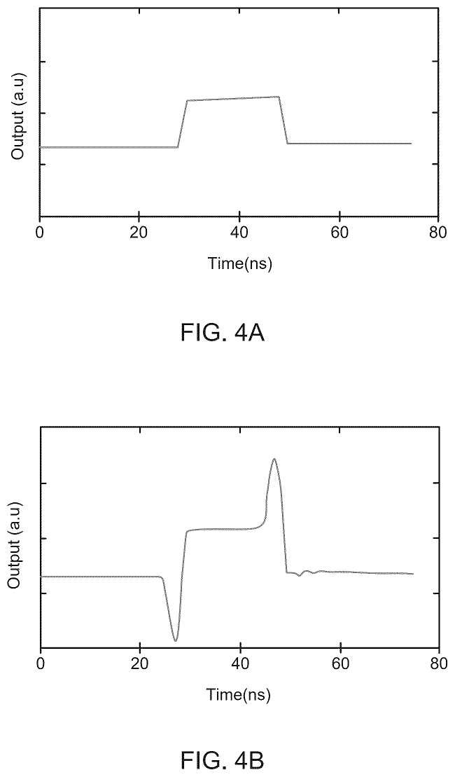

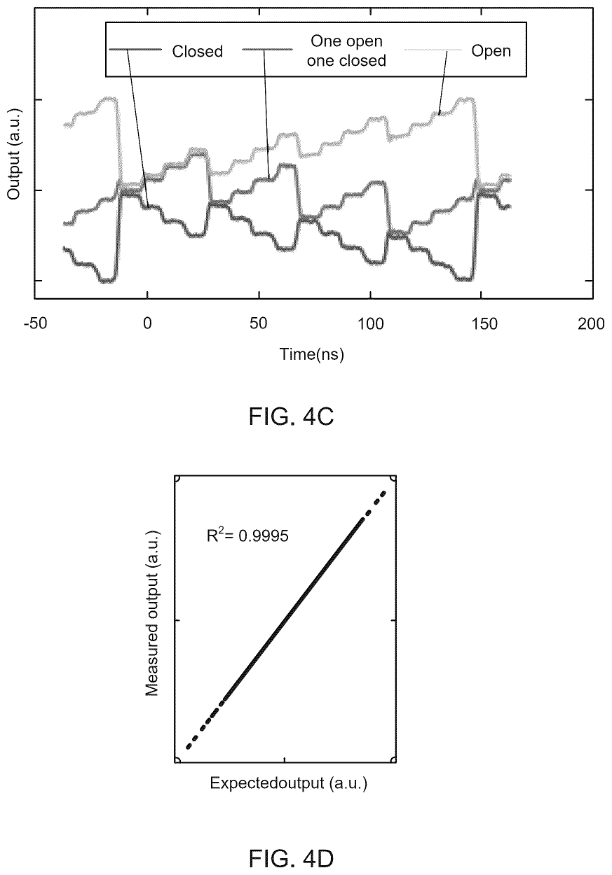

The inventors first characterized the timing of the positive and negative weights. For that purpose, a 20 ns square pulse at 1500 nm was inserted into a single input of the neuron. The output was measured by an oscilloscope (Keysight MXR604A), as shown in FIG. 4A. A delay line with length 40 cm, equivalent to a 2 ns delay, was then added to the optical path of the positive weights in order to show the negative and positive weights separately, as shown in FIG. 4B. The graph shows that the negative weights preceded the positive weights, and that the added spikes are indeed 2 ns long, as expected.

The inventors then inserted analog step functions with 4 levels into 2 inputs of the neuron, input1 with a 10 ns step period and input2 with 40 ns step period. The outputs were recorded at different states of the VOAs, shown in FIG. 4C. When both VOAs are closed, the positive weight is equal to zero, resulting in negative descending steps. When both VOAs are fully open, the intensity of the combined positive input is much higher than that of the combined negative input, leading to ascending steps. The state where one VOA is open and the other is closed is an intermediate state. The VOA of the shorter period input is open, so that input has a positive weight and hence displays ascending output. The VOA of the longer period input is closed, so it has a negative weighting and displays descending steps.

The inventors compared the output values measured by the dual balanced photodiode to the expected output values, as an assessment of the accuracy of the MAC operations, depicted in FIG. 4D. The inventors expect the plot to be linear for an ideal MAC calculator. The plot in FIG. 4D displays a linear fit with R\hat{ }2=0.9995, implying an excellent MAC accuracy of the neuron.

The inventors completed a prototype system comprising 16 input channels and 4-layer classifier, and tested the performance of this system. The inventors compared the prototype system's performance to Nvidia DGX A100, which is an industry standard, and to another photonic accelerator, LightMatter Envise server. The results have shown an acceleration of up to 20 times that of competing systems, with 2 orders of magnitude increase in power efficiency.

Thus, the present disclosure provides a neuron unit and photonic computing system utilizing such neuron units based on hybrid fiber technology and electro-optical communication devices, featuring positive and negative weighting scheme under incoherent data transmission conditions. The inventors showed that such design can achieve 5× to 20× acceleration while increasing power efficiency by over 100×.

1. An artificial neural unit for signal processing, the artificial neuron unit comprising:
a fiber-based optical processing unit having first and second light input ports and first and second light output ports, and being configured and operable to controllably apply optical processing to incoherent input light signals and produce weighted first and second combined light signals;
an electro-optical processing unit configured and operable to process said weighted first and second combined light signals and produce a total weighted output of the artificial neuron unit, by successively performing the following: applying a predetermined mathematical function to said weighted first and second combined light signals corresponding to positive and negative weighting and producing a resulting signal; and applying a non-linear processing to the resulting signal to translate said resulting signal into an optical output signal representing said total weighted output of the artificial neuron unit.

2. The artificial neural unit according to claim 1, wherein the electro-optical processing unit comprises: a linear processor having an optical input coupled to said first and second light output ports and being configured and operable to process said weighted first and second combined light signals by applying the predetermined mathematical function thereto corresponding to positive and negative weighting, and output a resulting electronic signal; and a non-linear processor adapted to receive an input signal indicative of the resulting electronic signal and configured and operable to translate said input signal into an optical output signal representing the total weighted output of said artificial neuron unit.

3. The artificial neural unit according to claim 1, wherein
the fiber-based optical processing unit comprises first and second splitters at said first and second light input ports and first and second combiners at the first and second light output ports, wherein the first splitter is configured to split the first light input port, by a predetermined ratio, into a first pair of separate first and second light propagation paths, the second splitter is configured to split the second light input port, by said predetermined ratio, into a second pair of separate first and second light propagation paths, the first combiner combines the first light propagation paths of the first and second pairs at the first light output port producing a first combined light signal, and the second combiner combines the second light propagation paths of the first and second pairs combined at the second light output port producing a second combined light signal, and
at least one of the first and second light propagation paths of each of the first and second pairs is configured to apply variable optical attenuation (VOA) to light propagating therethrough, thereby applying weighing to said incoherent input light signals propagating through at least one of the first and second light propagation paths of each of the first and second pairs, such that the first combined light signal and the second combined light signal are thereby respectively said weighted first and second combined light signals.

4. The artificial neural unit according to claim 2, wherein the non-linear processor is configured as an electro-optical device.

5. The artificial neural unit according to claim 4, wherein said linear processor comprises a dual balanced photodiode configured and operable to process said weighted first and second combined light signals and produce the electronic signal proportional to a difference between said weighted first and second combined light signals, thereby realizing, respectively, positive and negative weighting with the first and the second combined light signals.

6. The artificial neural unit according to claim 5, wherein the non-linear processor is configured as the electro-optical device based on electronic non-linearity of the dual balanced photodiode.

7. The artificial neural unit according to claim 2, wherein the non-linear processor is configured as an optical active device, the input signal being received by the non-linear processor being an optical signal corresponding to the resulting electronic signal output of the linear processor.

8. The artificial neural unit according to claim 1, further comprising a control board configured and operable to control operation of the fiber-based optical processing unit and the electro-optical processing unit.

9. The artificial neural unit according to claim 8, wherein the control board comprises: a weighting controller configured and operable to generate a control signal to the fiber-based optical processing unit to apply variable optical attenuation to light propagating through the optical processing unit; a linear controller configured and operable to define coefficients of said mathematical function corresponding to weighted summation of said weighted first and second combined light signals; and a non-linear controller configured and operable to define a shape of a non-linear function that translates the weighted summation to the optical output signal representing the total weighted output of the artificial neuron unit.

10. The artificial neural unit according to claim 2, wherein
the fiber-based optical processing unit comprises first and second splitters at said first and second light input ports and first and second combiners at the first and second light output ports, wherein the first splitter is configured to split the first light input port, by a predetermined ratio, into a first pair of separate first and second light propagation paths, the second splitter is configured to split the second light input port, by said predetermined ratio, into a second pair of separate first and second light propagation paths, the first combiner combines the first light propagation paths of the first and second pairs at the first light output port producing a first combined light signal, and the second combiner combines the second light propagation paths of the first and second pairs combined at the second light output port producing a second combined light signal, and
at least one of the first and second light propagation paths of each of the first and second pairs is configured to apply variable optical attenuation (VOA) to light propagating therethrough, thereby applying weighing to said incoherent input light signals propagating through at least one of the first and second light propagation paths of each of the first and second pairs, such that the first combined light signal and the second combined light signal are thereby respectively said weighted first and second combined light signals.

11. The artificial neural unit according to claim 2, wherein the non-linear processor is configured as an electro-optical device.

12. The artificial neural unit according to claim 11, wherein said linear processor comprises a dual balanced photodiode configured and operable to process said weighted first and second combined light signals and produce the electronic signal proportional to a difference between said weighted first and second combined light signals, thereby realizing, respectively, positive and negative weighting with the first and the second combined light signals.

13. The artificial neural unit according to claim 12, wherein the non-linear processor is configured as the electro-optical device based on electronic non-linearity of the dual balanced photodiode.

14. The artificial neural unit according to claim 2, wherein the non-linear processor is configured as an optical active device, the input signal being received by the non-linear processor being an optical signal corresponding to the resulting electronic signal output of the linear processor.

15. The artificial neural unit according to claim 2, further comprising a control board configured and operable to control operation of the fiber-based optical processing unit and the electro-optical processing unit.

16. The artificial neural unit according to claim 15, wherein the control board comprises: a weighting controller configured and operable to generate a control signal to the fiber-based optical processing unit to apply variable optical attenuation to light propagating through the optical processing unit; a linear controller configured and operable to define coefficients of said mathematical function corresponding to weighted summation of said weighted first and second combined light signals; and a non-linear controller configured and operable to define a shape of a non-linear function that translates the weighted summation to the optical output signal representing the total weighted output of the artificial neuron unit.

17. An artificial neural network comprising two or more neuron layers arranged such that optical input of a successive layer of said two or more layers is coupled to optical output of a preceding layer of said two or more neuron layers, wherein each of said two or more neuron layers is formed by a number of independently operable artificial neuron units, each artificial neuron unit being configured according to claim 1.

18. An artificial neural network comprising two or more neuron layers arranged such that optical input of a successive layer of said two or more layers is coupled to optical output of a preceding layer of said two or more neuron layers, wherein each of said two or more neuron layers is formed by a number of independently operable artificial neuron units, each artificial neuron unit being configured according to claim 2.
